(19) United States
(12) Patent Application Publication
(10) Pub. No.: US 2002/0144570 A1
(43) Pub. Date: Oct. 10, 2002

(54) Hermetically sealed power transmission

(76) Inventor: Mark A. Goold, Ipswich, MA (US)

Correspondence Address: Donald N. Halgren, 35 Central St., Manchester, MA, 01944, US

(21) Appl. No.: 10/156,566

(22) Filed: May 28, 2002

Related U.S. Application Data
(63) Continuation of application No. 09/546,808, filed on Apr. 11, 2000.

(51) Int. Cl. F16H 37/00

(52) U.S. Cl. 74/640

(57) ABSTRACT

The present invention covers a one-to-one ratio harmonic drive transmission for use between a pressure chamber and a vacuum chamber for power transmission therebetween, while also providing a pressure seal therebetween. The transmission includes a chamber wall dividing the vacuum chamber from a pressure chamber. An annular housing has a first end and a second end with an output shaft through the first end supported therein by a bearing supported arrangement. An input shaft is arranged through the wall and a generally cup-shaped flexspline is sealingly arranged about the input shaft. An outer wave generator and an inner wave generator are arranged with respect to the flexspline, to provide a one-to-one ratio of input to output, with the flexspline acting as a hermetic seal.

### BACKGROUND OF THE INVENTION

1. Field of the Invention

This invention relates to harmonic drive transmissions and more particularly to a sealed power transmission to permit power transmission operating straight through a hermetic seal.

2. Prior Art

Manufacturing operations often require a vacuum or a gas to be utilized from a supply to a moving system or rotating process. In the prior art however, ferrofluidic seals have been utilized to maintain a vacuum or gas purity in a moving or rotating process. Typically those fluidic seals form the basis of rotary unions utilized in different environments. Such fluidic arrangements utilize “O” rings which have their disadvantages. Such “O” rings wear out after a limited period of use in straight through shafts. Such fluidic seals are limited also to pressure differentials of only about 0.2 atmospheres. Power failures and electromagnetic interference may also cause a problem with such sealing arrangements.

It is an object of the present invention, to provide an improved power transmission from a non-vacuum to a vacuum side of a physical manufacturing operation.

It is a further object of the present invention to provide a hermetically sealed transmission with a one to one ratio, which is an improvement over the prior art.

It is yet still a further object of the present invention, to provide a power transmission through an atmosphere to vacuum arrangement.

### BRIEF SUMMARY OF THE INVENTION

The present invention comprises a hermetically sealed one to one harmonic drive actuator assembly power transmission from a vacuum side to a non-vacuum or pressure side of a chamber. The harmonic drive actuator assembly comprises a generally cylindrically shaped transmission housing. The transmission housing has a first end with an input shaft extending therethrough, and a second end with an output shaft therethrough, the output shaft in engagement with a driven member. The input shaft is supported within the first end of the housing by a pair of ball bearing arrangements. The input shaft has a innermost end with a circular flange thereon, within the housing.

A generally cylindrically shaped input wave generator is arranged in the housing, and has a first end which is attached to the peripheral edge of the generally circular flange on the inner end of the input shaft. The input wave generator has an open second end which having an inner peripheral edge resurface which is of generally slight elliptical “wave-generator” configuration, having a major axis and a minor axis. The second end of the input wave generator is annularly disposed radially outwardly of a midpoint of a cup shaped flexspline supported within the housing. The flexspline is fixedly attached to the second end of the housing. The flexspline has a closed inner end comprising a rear diaphragm. The flexspline also has a generally bell shaped front end with a front diaphragm annularly disposed radially inwardly from its outer peripheral edge. The front diaphragm is unitary with and joins a thick mounting flange at the second end of the housing. A channel or shoulder is arranged on the mounting flange in which to seat the peripheral edge of the second end of the housing. The mounting flange may be attached to a wall portion of the chamber, dividing the vacuum side of the chamber from the pressure or atmospheric side of the chamber.

An annular runner or thickened portion of the flexspline is arranged radially adjacent the second end of the input wave generator. An outer race of an outer wave generator bearing is arranged within the lip of the second end of the input wave generator. A plurality of ball bearings and an inner race are arranged radially outwardly of the annular runner, to comprise the outer wave generator bearing assembly.

An inner wave generator bearing assembly is arranged radially inwardly of the annular runner of the flexspline. The inner wave generator bearing comprises an inner race and an outer race with a plurality of ball bearings arranged therebetween. The inner race of the inner wave generator bearing is disposed on the peripheral surface of an output wave generator. The output wave generator is of generally elliptical configuration; having a major axis and a minor axis. The inner wave generator is mounted on an output shaft. The output shaft extends through an end plate which is secured to the mounting flange. The output shaft extends and is for communication with a driven member within the pressurized portion of the chamber.

The housing may have a vacuum port which is disposed therethrough, to provide a vacuum within the housing, directed generally radially outwardly of and away from the flexspline in the housing. The flexspline and its contiguous unitary mounting flange act as the seal between the vacuum and the pressure portions of the apparatus in which the power transmission is arranged. Thus a rotary input into the input shaft on the vacuum side of the apparatus provides a one to one ratio with the output shaft of the harmonic drive assembly with the flexspline comprising a hermetically sealed wall to function as a seal improving over the art with a longer lasting transmission. The higher pressure within the flexspline itself helps prevent possible buckling of that flexspline. A tie-bar may be arranged on the rear portion of the rear diaphragm of the flexspline to provide extra support and prevent excessive elongation and consequent high-stress stress to the front diaphragm of that flexspline. In the preferred embodiment, there are no spline teeth in this harmonic drive transmission. The thickness of the input wave generator is defined by the inner peripheral configuration, which is oval shaped, to have a minor axis and a major axis. The major axis of the outer or input wave generator in the preferred embodiment is in phase with the major axis of the inner wave generator, and in one embodiment, they may be out of phase, to produce torque changes.

The invention thus comprises a one-to-one ratio harmonic drive transmission for use between a pressure, chamber and a vacuum chamber for power transmission therebetween, while also providing a pressure seal therebetween, including a chamber wall dividing the vacuum chamber from a pressure; an annular housing having a first end and a second end with an input shaft through the first end supported therein by a bearing supported arrangement; an output shaft through the wall; a generally cup-shaped flexspline sealingly arranged about the output shaft; and an outer wave generator and an inner wave generator arranged with respect to the flexspline, to provide a one to one ratio of input to output, with the flexspline acting as a hermetic seal. The output wave generator has a major axis and the input wave generator each have a major axis. The major axes of the wave generators may be embodiment, be in phase with one another, and in another embodiment may be out of phase with one another. The flexspline has a radially inner volume which is pressurized. The housing may have a negative pressure therein. The housing has a vacuum port therein. The wave generators are in radial alignment with one another. The flexspline is sandwiched between the wave generators. The flexspline has a thickened runner on its surface between the wave generators. The wave generators may have spaced rollers therewith. The flexspline has a first end with a diaphragm thereacross. The flexspline has a second end with a diaphragm thereon. The second end of the diaphragm has a bell shape thereto. The diaphragm on the second end of the flexspline has a mounting flange arranged unitarily therewith. The mounting flange is sealingly secured to the chamber wall.

The invention also includes a method for the one-to-one transmission of rotary motion in a hermetically sealed manner from a vacuum chamber to a pressurized area, comprising the steps of: arranging an input shaft with an oval wave generator thereon; supporting an output shaft with an oval wave generator thereon, through a chamber wall; aligning the wave generators in radial alignment with one another; supporting a harmonic drive flexspline between the wave generators; and rotating the input shaft with respect to the output shaft while the flexspline provides a sealing arrangement therebetween; attaching the output shaft to a driven member; arranging a major axis of one of the wave generators to be in phase with the other of the wave generators; applying a vacuum to the chamber.

Thus what has been shown is a unique harmonic drive assembly, utilizing a first and a second wave generator acting in an out-of-phase relationship, and without a tooth engagement therebetween, to provide a one to one power transmission between a vacuum side and a pressurized side of a chamber in a manufacturing apparatus.

### BRIEF DESCRIPTION OF THE DRAWIGS

The objects and advantages of the present invention will become more apparent, when viewed in conjunction with the following drawings in which:

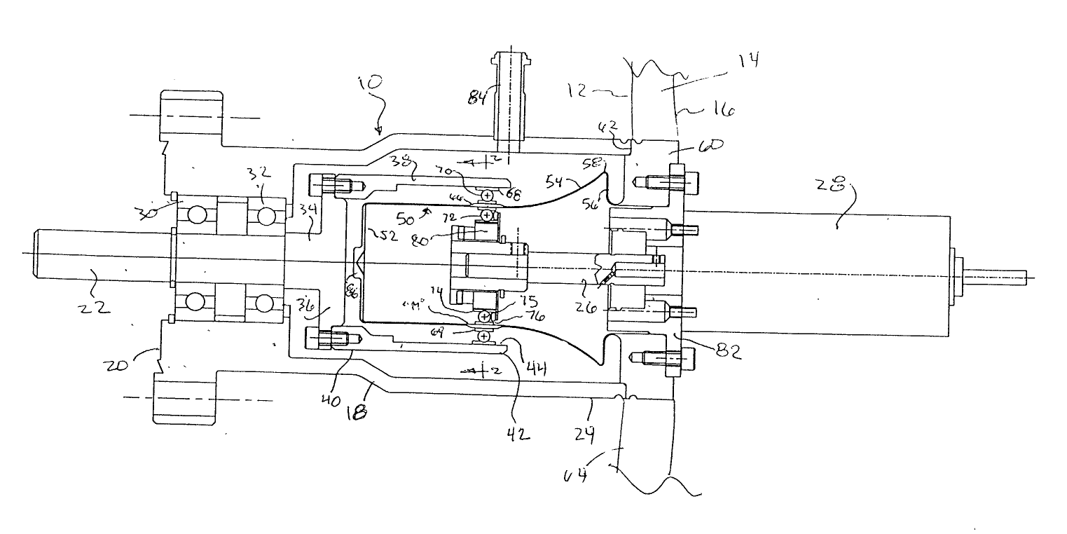

FIG. 1 is a side elevational view, in section, of a harmonic drive assembly constructed according to the principles of the present invention; and

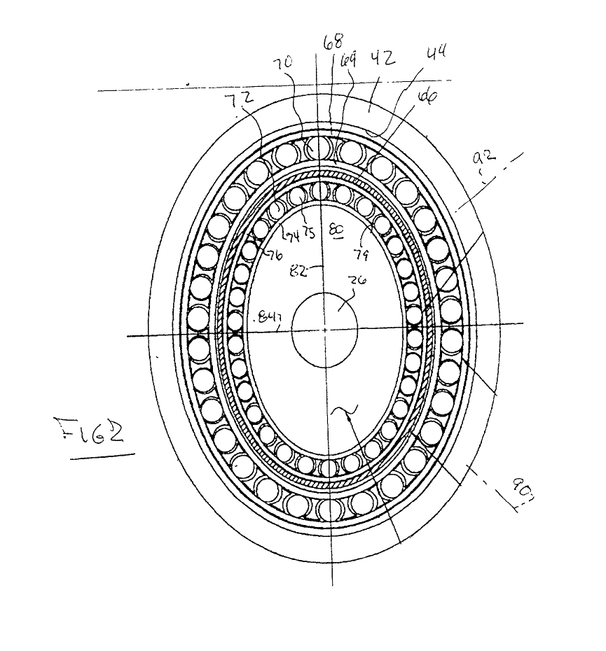

FIG. 2 is a view taken along the lines 2-2 of FIG. 1.

### DESCRIPTION OF THE PREFERRED EMBODIMENTS

Referring now to the drawings in detail, and particularly to FIG. 1, there is shown the present invention which comprises a hermetically sealed one-to-one harmonic drive actuator assembly power transmission 10 for transmitting rotary motion from a vacuum side 12 of a chamber 14 to a non-vacuum or pressure side 16 of the chamber 14. The harmonic drive actuator assembly 10 comprises a generally cylindrically shaped transmission housing 18. The transmission housing 18 has a first end 20 with an output shaft 22 extending therethrough, and a second end 24 with an input shaft 26 extending therethrough, the input shaft 26 in engagement with a drive member 28. The output shaft 22 is supported within the first end 20 of the housing 18 by a pair of ball bearing arrangements 30 and 32. The output shaft 22 has an innermost end 34 with a circular flange 36 thereon, disposed within the housing 18.

A generally cylindrically shaped first wave generator 38 is arranged in the housing 18, and has a first end 40 which is attached to the peripheral edge of the generally circular flange 36 on the inner end 34 of the output shaft 22. The first wave generator 38 has an open second end 42 which has an inner lip or peripheral edge surface 44 which is of generally slight oval “wave-generator” configuration, having a major axis 46 and a minor axis 48, as shown somewhat exaggerated, in FIG. 2. The second end 42 of the first wave generator 38 is annularly disposed radially outwardly of a midpoint “M” of a cup shaped flexspline 50 supported within the housing 18. The flexspline 50 is fixedly attached to the second end 24 of the housing 18. The flexspline 50 has a closed inner end 52 comprising a rear diaphragm. The flexspline 50 also has a generally bell shaped front end 54 with an annularly shaped front diaphragm 56 and disposed radially inwardly from its outer peripheral edge 58, as may be seen in FIG. 1. The front diaphragm 58 is unitary with and joins a thick mounting flange 60 at the second end 24 of the housing 18. A channel or shoulder 62 is arranged on the mounting flange 60 in which to seat the peripheral edge of the second end 24 of the housing 18. The mounting flange 60 may be attached to a wall portion 64 of the chamber 14, dividing the vacuum side 12 of the chamber 14 from the pressure or atmospheric side 16 of the chamber 14.

An annular runner 66 or thickened portion of the flexspline 50 is arranged radially adjacent the second end 42 of the first wave generator 38. An outer race 68 of an outer wave generator bearing 70 is arranged within the lip 44 of the second end 42 of the first wave generator 38. A plurality of ball bearings and an inner race 69 are arranged radially outwardly of the annular runner 66, to comprise the outer wave generator bearing assembly 70.

An inner wave generator bearing assembly 72 is arranged radially inwardly of the annular runner 66 of the flexspline 50. The inner wave generator bearing 72 comprises an inner race 74 and an outer race 76 with a plurality of ball bearings 75 arranged therebetween. The inner race 74 of the inner wave generator bearing assembly 72 is disposed on the peripheral surface 79 of an output wave generator 80. The innermost (output) wave generator 80 is of generally oval or elliptical configuration, having a major axis 82 and a minor axis 84, as may be seen in FIG. 2. The innermost wave generator 80 is mounted on the input shaft 26. The input shaft 26 extends rotatively through an end plate 82 which is secured to the mounting flange 60. The input shaft 26 extends and is in communication with the drive member 28 within the pressurized portion 16 of the chamber 14.

The housing 18 may have a vacuum port 84 which is disposed therethrough, to provide a vacuum within the housing 18, directed generally radially outwardly of and away from the flexspline 50 in the housing 18. The flexspline 50 and its contiguous unitary mounting flange 60 act as the seal between the vacuum and the pressure portions 12 and 16 of the apparatus 10 in which the power transmission is arranged. Thus a rotary input into the input shaft 26 on the atmospheric side 12 of the assembly 10 provides a one to one ratio with the output shaft 22 of the harmonic drive assembly 10 with the flexspline 50 comprising a hermetically sealed wall to function as a seal, greatly improving over the art with a longer lasting transmission. A higher pressure within the flexspline 50 itself helps prevent possible buckling of that flexspline 50. A tie-bar 86 may be arranged on the rear portion of the rear diaphragm 52 of the flexspline 50 to provide extra support and prevent excessive elongation and consequent high-stress to the front diaphragm 56 of that flexspline 50. There are preferably no spline teeth in this harmonic drive transmission assembly 10. The thickness of the output (outermost) wave generator 42 is defined by the inner peripheral configuration, which has a minor axis 90 and a major axis 92. In one preferred embodiment, they are in phase with one another. In another embodiment, the major axis 92 of the outermost or input wave generator 42 may be out of phase with the major axis 82 of the inner wave generator 42, to produce a different output torque.

Thus what has been shown is a unique harmonic drive assembly, utilizing a first and a second wave generator acting in a phased relationship, and without a tooth engagement therebetween, to provide a one to one power transmission between a vacuum side and a pressurized side of a chamber in a manufacturing apparatus.

1. A one-to-one ratio harmonic drive transmission for use between a pressure chamber and a vacuum chamber for power transmission therebetween, while also providing a pressure seal therebetween, including
a chamber wall dividing said vacuum chamber from a pressure;
an annular housing having a first end and a second end with an output shaft through said first end supported therein by a bearing supported arrangement;
an input shaft through said wall;
a generally cup-shaped flexspline sealingly arranged about said input shaft; and
an outer wave generator and an inner wave generator arranged with respect to said flexspline, to provide a one to one ratio of input to output, with said flexspline acting as a hermetic seal.

2. A one-to-one ratio harmonic drive transmission as recited in claim 1, wherein said output wave generator has a major axis and said input wave generator has a major axis, said major axis of said wave generators being in phase with one another.

3. A one-to-one ratio harmonic drive transmission as recited in claim 1, wherein said output wave generator has a major axis and said input wave generator has a major axis, said major axis of said wave generators being out of phase with one another.

4. A one-to-one ratio harmonic drive transmission as recited in claim 2, wherein said flexspline has a radially inner volume which is at atmospheric pressure.

5. A one-to-one ratio harmonic drive transmission as recited in claim 2, wherein said housing has a negative pressure therein.

6. A one-to-one ratio harmonic drive transmission as recited in claim 5, wherein said housing has a vacuum port therein.

7. A one-to-one ratio harmonic drive transmission as recited in claim 1, wherein said wave generators are in radial alignment with one another.

8. A one-to-one ratio harmonic drive transmission as recited in claim 7, wherein said flexspline is sandwiched between said wave generators.

9. A one-to-one ratio harmonic drive transmission as recited in claim 7, wherein said flexspline has a thickened runner on its surface between said wave generators.

10. A one-to-one ratio harmonic drive transmission as recited in claim 7, wherein said wave generators are spaced rollers.

11. A one-to-one ratio harmonic drive transmission as recited in claim 7, wherein said flexspline has a first end with a diaphragm thereacross.

12. A one-to-one ratio harmonic drive transmission as recited in claim 7, wherein said flexspline has a second end with a diaphragm thereon.

13. A one-to-one ratio harmonic drive transmission as recited in claim 12, wherein said second end of said diaphragm has a bell shape thereto.

14. A one-to-one ratio harmonic drive transmission as recited in claim 13, wherein said diaphragm on said second end of said flexspline has a mounting flange arranged unitarily therewith.

15. A one-to-one ratio harmonic drive transmission as recited in claim 14, wherein said mounting flange is sealingly secured to said chamber wall.

16. A method for the one-to-one transmission of rotary motion in a hermetically sealed manner from a vacuum chamber to a pressurized area, comprising the steps of:
arranging an input shaft with an oval wave generator thereon;
supporting an output shaft with a generally elliptically shaped wave generator thereon, through a chamber wall;
aligning said wave generators in radial alignment with one another;
supporting a harmonic drive flexspline between said wave generators; and
rotating said input shaft with respect to said output shaft while said flexspline provides a sealing arrangement therebetween to provide such a one to one power output.

17. The method for the one-to-one transmission of rotary motion as recited in claim 16, including the step of:
attaching said input shaft to a drive member.

18. The method for the one-to-one transmission of rotary motion as recited in claim 16, including the step of:
arranging a major axis of one of said wave generators to be out of phase with the major axis of the other of said wave generators.

19. The method for the one-to-one transmission of rotary motion as recited in claim 17, including the step of:
applying a vacuum to said chamber.
